(19) United States
(12) Patent Application Publication
(10) Pub. No.: US 2015/0013681 A1
(43) Pub. Date: Jan. 15, 2015

(54) Apparatus with Exhaust Spacer to Improve Filtration of Pathogens in Respiratory Emissions of Sneezes

(71) Applicant: Lee Stockhamer, Tarrytown, NY (US)

(72) Inventor: Lee Stockhamer, Tarrytown, NY (US)

(21) Appl. No.: 14/321,275

(22) Filed: Jul. 1, 2014

Related U.S. Application Data
(60) Provisional application No. 61/957,434, filed on Jul. 2, 2013.

(51) Int. Cl. A62B 23/00; A62B 23/02

(52) U.S. Cl. CPC A62B 23/00; A62B 23/025
USPC 128/206.14; 128/206.19; 55/413; 96/223; 96/417; 95/273

(57) ABSTRACT

Apparatus and method to mitigate the spread of respiratory emission of a sneeze are disclosed. The apparatus includes a spacer component and at least one filtration component. The at least one filtration component is disposed atop the spacer component. The spacer component includes a corrugated sheet, which forms a plurality of directional flutes to direct filtered air out of the apparatus. The least one filtration component filters the respiratory emission to produce the filtered air. In accordance with the method, the respiratory emission is filtered through at least one filtration component to produce filtered air, and the filtered air is directed through a spacer component comprising a corrugated sheet, which forms a plurality of directional flutes that direct the filtered air out of the apparatus.

### CROSS REFERENCE TO RELATED APPLICATION

This application claims priority to U.S. Provisional Patent Application No. 61/957,434 filed on Jul. 2, 2013, which is incorporated herein by reference in its entirety.

### BACKGROUND

1. Field of Technology

The present application relates generally to devices for receiving the respiratory emissions of sneezes and coughs. More specifically, the present application is directed to an apparatus to mitigate the spread of disease caused by pathogens in respiratory emission of a sneeze and/or a cough. The description that hereinafter references a sneeze shall also refer to a cough.

2. Brief Discussion of Related Art

In the healthcare field and other fields (e.g., food service, customer service), as well as in everyday life, the practice of reducing the spread of disease through respiratory emissions of a sneeze and/or a cough (e.g., 1-4 liters of air, large and small liquid droplets, aerosol, and mucus) that contain pathogens (e.g., bacteria, viruses and other pathogens) has become vitally important. Many are sickened, some very seriously and even fatally, by the pathogens in these emissions. Healthcare Associated Infections (HAIs) cost society billions of dollars each year. Government and private insurers now deny reimbursement to hospitals for the treatment of preventable HAIs, and consumer and government pressure have led some hospitals to publicly disclose their HAI rates. The World Health Organization (WHO) released a report in 2014 declaring that we are now in a “Post-Antibiotic Era” in which antibiotic resistance can make common diseases such as Pneumonia deadly on a widespread basis and declared that due to this new situation, prevention is now critically important. Moreover, a contemporary study by Lydia Bouroiba of MIT Dept. of Mathematics—“Violent Expiratory Events: On Coughing And Sneezing,” Journal of Fluid Mechanics, 745 April 2014, pp. 537-563—reported new insights into the nature of respiratory clouds, demonstrating that smaller particles can travel 5-200 times farther than previously believed.

The FDA, which regulates 510K submissions of medical masks (e.g., surgical, procedure, laser, isolation) and respirators (hereinafter “masks”), states that the medical masks, by design, do not protect anyone from infectious aerosol and that the medical respirators solely protect the wearer. Mask manufacturers publish bacterial filtration efficiency (BFE) and particle filtration efficiency (PFE) for masks, with filtration efficiency rates that range between 97% and 99% based upon tests in laboratory conditions that simulate breathing, in which tests all emissions are forced through the masks. However, in real world usage, especially with sneezes, the masks achieve far lower rates by the very nature of their design and material. While the masks do block some of the larger droplets produced by sneezes they are overwhelmed by the large volume of air, droplets and aerosol produced in a fraction of second by a sneeze. As such, much of the emissions take the path of least resistance out of the sides and tops of these masks.

The United States Centers for Disease Control and Prevention (CDC) and the Department of Health and Human Services (HHS) recommend reducing the spread of such pathogens by promoting the practice of “respiratory etiquette” (e.g., covering one's nose and mouth when sneezing). Because the common practice of covering one's mouth with one's hand when sneezing results in hand, air and object contamination, the CDC, among other measures, instructs people to cover the mouth and nose using a conventional tissue or a clothing sleeve in order to prevent the spread of disease through such respiratory emissions.

Another study by J. W. Tang et al.—“Qualitative Real-Time Schlieren and Shadowgraph Imaging of Human Exhaled Airflows: An Aid to Aerosol Infection Control,” published by National Institutes of Health (NIH) on Jun. 22, 2011—identified some of the problems encountered in trying to stop emissions of sneezes as described hereinabove. The study found that even under laboratory conditions, the subject often could not get the tissue into proper position in time, especially with sneezes, which occurred with less warning than coughs. Second, the study cited inconsistency of tissue deployment (e.g., tissue and hand positioning), which produced inconsistent filtration efficiency rates. Third, the study noted social and cultural constraints of using the sleeve per CDC guidelines, which leaves infectious material on the sleeve or the arm. Finally, the study noted that in real life, holding shopping bags, young children, and other real world events, often make tissue deployment impractical. Such constraints would similarly plague medical and/or food service personnel that have both hands occupied.

Furthermore, even when a tissue is deployed correctly, the sneezer's hands and clothing, as well as surrounding air and objects often become contaminated because the emission of the sneeze penetrates through or past the tissue. In addition, the filtration efficiencies of two three-ply tissues (e.g., six plys in total), even if the entire emission of sneeze were filtered through these tissues, remains unsatisfactory. Accordingly, it would be desirable to provide an apparatus that offers improved filtration efficiencies of the pathogens in respiratory emissions resulting from a sneeze, as well as an apparatus that can be used with and without a mask.

### SUMMARY

In accordance with an embodiment, an apparatus to mitigate the spread of pathogens in a respiratory emission of a sneeze or a cough is disclosed. The apparatus includes a spacer component and at least one filtration component. The at least one filtration component is disposed atop the spacer component. The spacer component includes a corrugated sheet that forms a plurality of directional flutes to direct filtered air out of the apparatus. The at least one filtration component filters the respiratory emission to produce the filtered air.

In accordance with another embodiment, a method of mitigating the spread of pathogens in a respiratory emission of a sneeze or a cough is disclosed. The respiratory emission is filtered through at least one filtration component to produce filtered air, and the filtered air is directed through a spacer component including a corrugated sheet, which forms a plurality of directional flutes that direct the filtered air along the directional flutes.

In accordance with a further embodiment, a system to mitigate the spread of pathogens in a respiratory emission of a sneeze or a cough is disclosed. The system includes a mask and an apparatus. The mask partially filters the respiratory emission to produce a partially filtered respiratory emission. The apparatus includes a spacer component and at least one filtration component. The spacer component includes a corrugated sheet, which forms a plurality of directional flutes to direct filtered air out of the apparatus. The at least one filtration component is disposed atop the spacer component, which filters the partially filtered respiratory emission to produce the filtered air.

For a more thorough understanding of the present invention, reference is made to the following description, taken in conjunction with the accompanying drawings, and its scope will be pointed out in the appended claims.

### BRIEF DESCRIPTION OF THE DRAWINGS

Some embodiments are illustrated by way of example and not limitation in the figures of the accompanying drawings in which:

FIG. 1 illustrates a front isometric view of a first embodiment of an example apparatus to mitigate the spread of pathogens in a respiratory emission of a sneeze;

FIG. 2 illustrates an exploded cutaway view of the apparatus illustrated in FIG. 1, which illustrates the construction of the apparatus in greater detail;

FIG. 3 illustrates the components of the apparatus of FIG. 1 in greater detail;

FIG. 4 illustrates the securement of the components of the apparatus of FIG. 1 in greater detail;

FIG. 5 illustrates a front isometric view of a second embodiment of an example apparatus to mitigate the spread of pathogens in a respiratory emission of a sneeze;

FIGS. 6a and 6b illustrate cross-sectional views of example constructions of the apparatuses illustrated in FIGS. 1 and 5, respectively;

FIG. 7 illustrates top plan view of the apparatuses illustrated in FIGS. 1 and 5;

FIG. 8 illustrates a rear isometric view of the example apparatus illustrated in FIG. 1;

FIG. 9 illustrates a rear isometric view of another embodiment of an example apparatus to mitigate the spread of pathogens in a respiratory emission of a sneeze;

FIG. 10 illustrates example placement of the example apparatuses in accordance with FIGS. 1, 5 and 9;

FIGS. 11 and 12 illustrate the example operation of apparatuses in accordance with FIGS. 1, 5 and 9;

FIG. 13 illustrates an exploded cutaway view of the apparatus illustrated in FIG. 2, which illustrates filtration of the respiratory emission through the apparatus;

FIG. 14 illustrates the components of yet another embodiment of an example apparatus to mitigate the spread of pathogens in a respiratory emission of a sneeze;

FIG. 15 illustrates the securement of the components of the apparatus illustrated in FIG. 14;

FIG. 16 illustrates example placement of the example apparatus in accordance with FIG. 14;

FIG. 17 illustrates the example operation of apparatus illustrated in FIG. 14; and

FIG. 18 illustrates an exploded cutaway view of the assembled apparatus illustrated in FIG. 14, which illustrates filtration of the respiratory emission through the apparatus.

### DETAILED DESCRIPTION

An apparatus, a system and a method of mitigating the spread of pathogens in a respiratory emission of a sneeze are disclosed. In the following description, for the purposes of explanation, numerous specific details are set forth in order to provide a thorough understanding of example embodiments. It will be evident, however, to one skilled in the art, that an example embodiment can be practiced without all of the disclosed specific details.

FIG. 1 illustrates front isometric view of a first embodiment of an example apparatus 100 to mitigate the spread of pathogens in a respiratory emission of a sneeze. The example apparatus 100 has a configuration that conforms to a person's nose and mouth region. More specifically, the example apparatus 100 of FIG. 1 has substantially elliptical lower portion that conforms to a person's mouth region and a substantially triangular-circular upper portion that conforms to the person's nose region. Other configurations that conform to the person's nose and mouth region can be used.

The example apparatus 100 of FIG. 1 includes a stacked arrangement of a first filtration component 102, a second filtration component 104, and a spacer component 106. In some embodiments, the first filtration component 102 can be omitted from the apparatus 100.

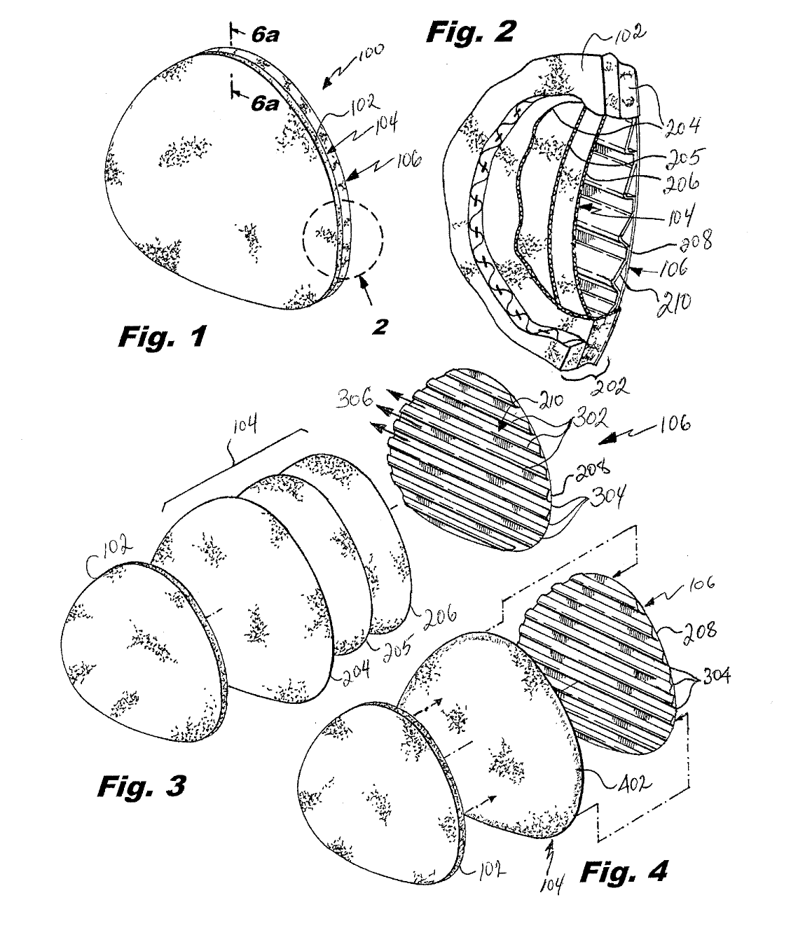

The first filtration component 102 receives respiratory emission of a sneeze (e.g., air, large and small liquid droplets, and aerosol) of a user and provides a partial filtering of the respiratory emission, e.g., outputting a partially-filtered respiratory emission to the second filtration component 104. The first filtration component 102 can be an antimicrobial component that provides, among other properties set forth below in reference to FIG. 3, antimicrobial properties that can also include virucidal properties. Other filtration components, including similar or different properties, can be used as alternatives to the first filtration component 102.

More specifically, the first filtration component 102 receives the respiratory emission of a sneeze of a user, inhibits microbial activity in the respiratory emission, and kills the bacteria and viruses in the respiratory emission. Moreover, the first filtration component 104 also channels and absorbs a first portion of the respiratory emission (e.g., large parts and droplets of moisture present in the respiratory emission). A remaining portion of the respiratory emission (e.g., partially-filtered respiratory emission), such as smaller parts and droplets present in the respiratory emission, is output or exits from the first filtration component 102 to the second filtration component 104. It should be noted that the first filtration component 102 also mitigates and/or inhibits microbial activity before the use by the user, such as when someone else coughs and/or sneezes in vicinity of the user wearing the apparatus 100, and some of the respiratory emission of such cough or sneeze makes contact with the first filtration apparatus 102.

The second filtration component 104 receives the partially-filtered respiratory emission of the first filtration component 102, and outputs air of the sneeze of the user that is substantially devoid of the pathogens (e.g., filtered air) to the spacer component 106. The second filtration component 104 can be a virucidal component that provides, among other properties set forth below in reference to FIG. 3, virucidal properties. Other filtration components, including similar or different properties, can be used as alternatives to the second filtration component 102.

More specifically, the second filtration component 104 receives the partially-filtered respiratory emission from the first filtration component 102 and mitigates and/or destroys virus activity in the partially-filtered respiratory emission. The second filtration component 104 also absorbs a second portion of the respiratory emission (e.g., smaller parts, droplets and aerosol).

It should be noted that a substantial portion of the pathogens in the respiratory emission produced by the sneeze of the user is thus filtered, as well as a substantial portion of the parts and droplets in the respiratory emission absorbed, by the combination of the component 102, 104.

In those embodiments where the first filtration component 102 is omitted from the apparatus 100, the second filtration component 104 can be modified such that second filtration component 104 mitigates and/or destroys microbial and virus activity, as well as substantially filters a substantial portion of the respiratory emission produced by the sneeze of the user, as will be described in greater detail below with reference to FIGS. 3 and 4.

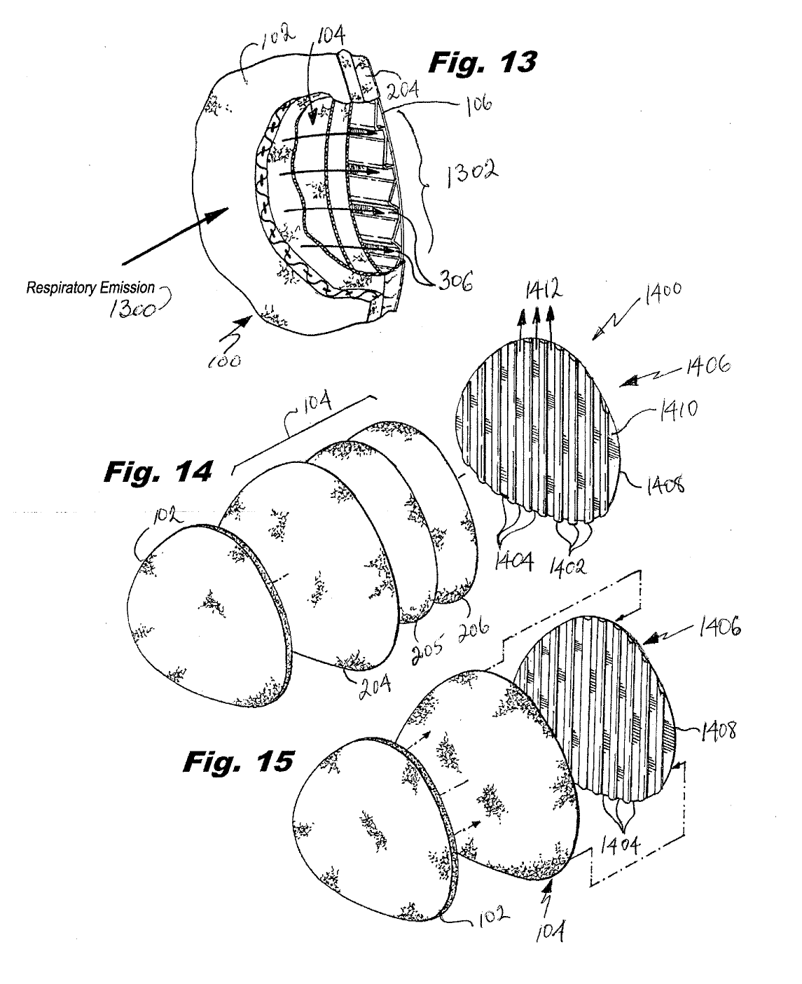

The spacer component 106 channels the filtered air to the outside of the example apparatus 100, as will be described in greater detail below with reference to FIG. 13. At this point it is sufficient to mention that the spacer component 106 incorporates a corrugated sheet, which provides a plurality of flutes to direct and/or exhaust the filtered air received from the second filtration component 104 to the outside the example apparatus 100.

FIG. 2 illustrates an exploded cutaway view of the apparatus 100 illustrated FIG. 1 to illustrate the construction of the apparatus 100.

More specifically, the first filtration component 102 is disposed atop the second filtration component 104, which can include a plurality of filtration elements 204-206, which will be described in greater detail with reference to FIG. 3. In various embodiments, there can be greater or fewer filtration elements than are illustrated in FIG. 2.

In this embodiment, at least one or more of the filtration elements 204-206 (e.g., filtration element 204) of the second filtration component 104 extends beyond the periphery of the spacer component 106, which creates a more uniform peripheral edge 202 of the apparatus 100. Moreover, the peripheral edge 202 provides the ability to make the apparatus 100 more economically and thinly. It should be noted that fewer filtration elements can be provided to achieve similar filtration of the partially-filtered respiratory emission that is received from the first component 104, or the respiratory emission that is received from the user in those embodiments where the first filtration component is omitted. For example, any remaining respiratory emission exiting through the bottom the second filtration component 104 can be filtered through filtration element 204 along the peripheral edge 202 before the filtered air exits the apparatus 100.

The second filtration component 104 is disposed atop the spacer component 106, which includes a linerboard (e.g., backing sheet) 208 and a corrugated sheet 210. The corrugated sheet 210 forms a plurality of flutes (e.g., directional flutes), which can direct and/or exhaust the filtered air received from the second filtration component 104 to the outside the example apparatus 100. In some embodiments, the linerboard 208 illustrated in FIG. 2 can be omitted from the spacer component 106, as long as the corrugated sheet 210 is flexible yet sufficiently rigid to maintain its corrugation, e.g., the plurality of flutes that can maintain open space to direct and/or exhaust the filtered air received from the second filtration component 104 to the outside of the example apparatus 100. Some of the plurality of flutes can be blocked with wadding, adhesive or other materials in order to direct and/or exhaust the filtered air in a desired direction.

FIG. 3 illustrates the components 102, 104 and 106 of the apparatus 100 in greater detail.

As already described hereinabove, the first filtration component 102 receives the respiratory emission of a sneeze of a user and outputs a partially-filtered respiratory emission to the second filtration component 104.

The first filtration component 102 is a filtration element made of “4 OPSY High FS Blend” by Foss Mfg. LLC of Hampton, N.H., a material which includes a combination of Ecofi® polyester for moisture channelling, Fosshield® for antimicrobial properties, and Rayon for absorption. Antimicrobial fabrics and textiles are well known in the art and the filtration element of the first filtration component 102 can be made of any fiber-based substrate to which antimicrobial agents have been applied to the surface, or incorporated into the fibers, rendering a product that kills or inhibits the growth of microorganisms and/or viruses. Moreover, the first filtration component 102 can also be made of multiple filtration elements.

The second filtration component 104 includes a plurality of filtration elements 204-206. For example, one or more of the filtration elements 204 and 206 can be Kleenex® Anti-Viral*Tissues (e.g., tissues) by Kimberly-Clark Corp. of Neenah, Wis., or one or more plys of such tissues. Each of the tissues is generally made of three (3) plys (not shown) including soft outer plys and an anti-viral (e.g., virucidal) center ply. It should be noted that while only two filtration elements 204, 206 are shown, fewer or more of the filtration elements, and/or the plys of the filtration elements, can be provided in second filtration component 104. It should further be noted that other suitable materials could be used for 204, 206 such as spunbond polypropylene, cellulose, medical grade tissue, standard facial tissues, other similar materials, as well as combinations of materials.

The filtration element 205 is disposed between filtration elements 204, 206. The filtration element 205 can be a material that is meltbond, a spun-bond, another material, as well as combinations of materials. For example, meltbond can be added to spunbond, forming SM or SMS webs, which can enhance filtering properties. Moreover, electrostatic properties can be imparted to some of these materials to increase both filtration and antimicrobial attraction. The filtration element 205 can be disposed between any pair of filtration elements (e.g., filtration element 204, 206), if a greater number of filtration elements is provided in the second filtration component 104. Similarly, the filtration element 205 can be disposed below a top filtration element (e.g., filtration element 204) or below a bottom filtration element (e.g., filtration element 206) of the second filtration component 104.

In some embodiments, the filtration element 205 can also be omitted. For example, the filtration element 205 can be omitted in embodiments where the apparatus 100 is used with a mask, which can provide the function of the filtration element 205.

The spacer component 106 includes a linerboard 208 and a corrugated sheet 210 forming flutes 306. The spacer component 106 can be made of corrugated fiberboard (also known as corrugated cardboard), paper, plastic, or another material. The linerboard 208 is generally planar. As described hereinbefore, the linerboard 208 can be omitted, as long as the corrugated sheet 210 is flexible yet sufficiently rigid to maintain its corrugation. Flexibility can improve conformance to the user's arm as well as offer softness to the user's face. The corrugated sheet 210 includes a plurality of peaks 302, and a plurality of valleys 304 between the peaks 302. The peaks 302 and valleys 304 thus form flutes 306 that direct and/or exhaust the filtered air received from the second filtration component 104 to the outside the example apparatus 100. It is noted that in this embodiment the flutes 306 are disposed horizontally across the apparatus 100.

FIG. 4 illustrates the securement of the components 102, 104 and 106 of the apparatus 100 in greater detail.

More specifically, the first filtration component 102 is secured atop the second filtration component 104 using an adhesive 402 applied about the periphery of the second filtration component 104, or one or more spots of adhesive (not shown) applied about the periphery and/or other portions of the second filtration component 104. Other mechanisms of securing the first filtration component 102 atop the second filtration component 104 are possible, such as thermo-bonding.

The filtration elements 204, 205, and 206 of second filtration component 104 can be secured to each other in a similar fashion as the filtration components 102, 104, e.g., using adhesive applied about the periphery of a filtration element (e.g., filtration element 205 (not shown) or one or more spots of adhesive (not shown) applied about the periphery and/or other portions of the filtration element.

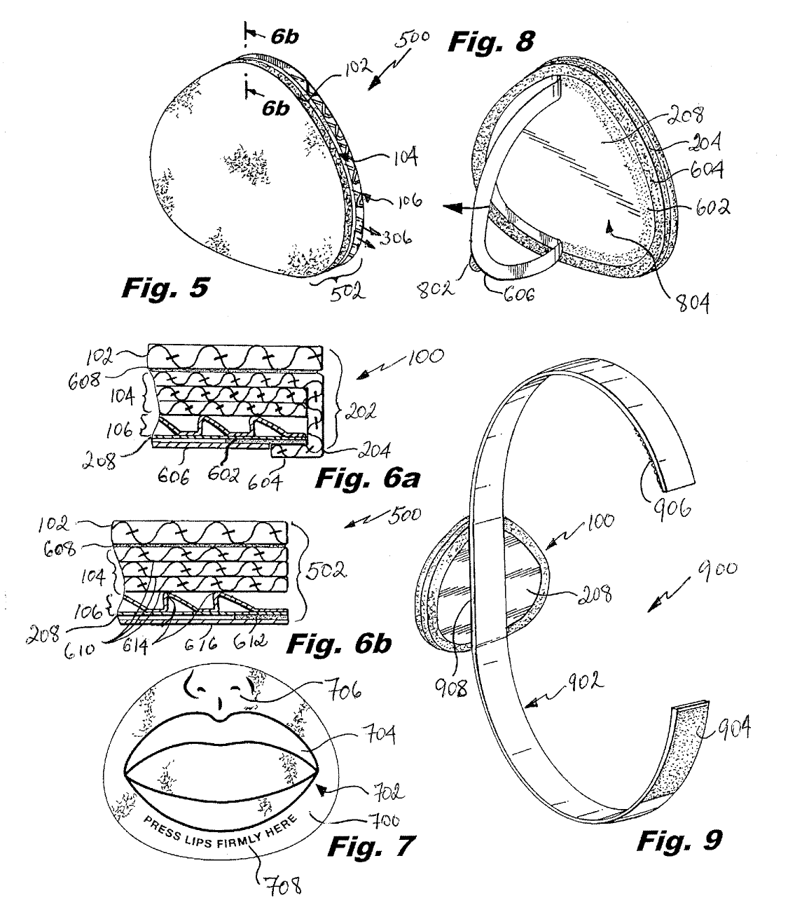

The second filtration component 104—or more particularly, one or more of the filtration elements 204-206—is secured to the underside of the spacer component 106 (e.g., linerboard 208) using an adhesive, e.g., as described in greater detail with reference to FIG. 6a. In the embodiments where the linerboard 208 is omitted (not shown), the second filtration component 104 is secured to the then underside of the spacer component 106 (e.g., corrugated sheet 210) also using an adhesive.

In some embodiments, the filtration elements 204, 205, 206 are not secured to each other, or are less securely attached to each other, because the filtration element 204 secured to the underside of the spacer component 106 encompassing the filtration elements 205, 206 securely in fixed position in relation to the spacer component 106.

FIG. 5 illustrates a front isometric view of a second embodiment of an example apparatus 500 to mitigate the spread of pathogens in a respiratory emission of a sneeze.

The apparatus 500 is generally similar to the apparatus 100, which is described with reference to FIGS. 1-4.

However, in this embodiment none of the filtration elements 204-206 extends beyond the periphery of the spacer component 106. More specifically, the peripheral edge 502 shows that the flutes 306 are open to the outside of the apparatus 500, e.g., not covered by the first component 104.

Accordingly, the filtered air simply exits the apparatus 500 along the flutes 306. In contrast to the apparatus 100, no filtration occurs at the peripheral edge 502 of the apparatus 500. Additional one or more filtration elements can be provided in the second filtration component 104 to account for the no filtration at the peripheral edge 502, such that filtered air can be exhausted along the flutes 306.

FIGS. 6a and 6b illustrate cross-sectional views of example constructions of the apparatuses 100, 500 of FIGS. 1 and 5, respectively.

As illustrated in FIG. 6a, the filtration element 204 of the second filtration component 104 extends beyond the periphery of the apparatus 100. A portion 604 of the filtration element 204 is secured to the linerboard 208 of the spacer component 106 using an adhesive 602, in a similar fashion as described hereinabove in reference to FIG. 4. The foregoing secures the second filtration component 104 to the spacer component 106.

The adhesive 602 also secures a removable backing 606, which can be peeled away by the user to expose a portion of the adhesive 602 used to secure the apparatus 100 to the clothing or the skin of the user. The filtration elements 204-206 of the second filtration component 104 can but do not have to be secured to each other, and/or to the corrugated sheet 210, as described hereinabove with reference to FIG. 4.

Moreover, the first filtration component 102 is secured to the second filtration component 104 by an adhesive 608, in a similar fashion as described hereinabove in reference to FIG. 4. The construction of the apparatus 100 provides a peripheral edge 202, as also described hereinabove.

As illustrated in FIG. 6b, the filtration elements 204-206 of the second filtration component 104 are secured to each other by using an adhesive 610, in a similar fashion as described hereinabove in reference to FIG. 4.

A removable backing 616 is secured about the periphery of the linerboard 208 of the spacer component 106 using an adhesive 612. The removable backing 616 can be peeled away by the user to expose the adhesive 612 used to secure the apparatus 100 to the clothing or the skin of the user.

Moreover, the second filtration component 104 is secured to the spacer component 106 using adhesive 614, for example, being secured to the peaks 302 as shown in FIG. 3. In the apparatus 500, the adhesive 612 can be disposed more proximate to the periphery of the spacer component 106 because the second filtration component 104 is not secured to the spacer component 106. Moreover, less adhesive 612 can be used also because the second filtration component 104 is not secured to the spacer component 106.

The first filtration component 102 of the apparatus 500 is secured to the second filtration component 104 by the adhesive 608, as described hereinabove with reference to FIG. 6a of the apparatus 100. The construction of the apparatus 500 provides a peripheral edge 502.

FIG. 7 illustrates top plan view of the apparatuses 100, 500 of FIGS. 1 and 5. An indicator 702 is disposed on a top surface 700 of the apparatuses 100, 500.

The indicator 702 includes a mouth 704, a nose 706 and text 708. The indicator 702 can be printed or painted by various techniques. The mouth 704 and the nose 706 aid the user in placing the user's mouth/nose region in appropriate relation (e.g., mouth being centered) to the apparatuses 100, 500.

The text 708 instructs the user to press the user's lips firmly against the apparatuses 100, 500. Pressing the mouth firmly, enables the nostrils to also press to firmly, against the apparatuses 100, 500, enabling virtually all of the respiratory emission from the sneeze to be deposited onto/into the top surface of the apparatuses 100, 500 and to mitigate escape of the respiratory emission.

FIG. 8 illustrates a rear isometric view of the example apparatus 100 illustrated in FIG. 1.

As illustrated in FIG. 8, the filtration element 204 of the second filtration component 104 extends beyond the periphery of the apparatus 100, with the portion 604 of the filtration element 204 being secured to the linerboard 208 of the spacer component 106 using a first portion of the adhesive 602.

Moreover, the backing 606 is removeably attached to the linerboard 208 by a second portion of the adhesive 602 and can be peeled away as indicated by the black arrow, exposing the second portion of the adhesive 602 about the periphery of the apparatus 100, such that the apparatus 100 can be attached to the user's clothing or skin. The backing 606 is a narrow strip contoured to the apparatus 100. The backing 606 can include a tab 802 to help the user in peeling the backing 606 off the apparatus 100.

Similarly with respect to the apparatus 500, the backing 616 is removeably attached to the linerboard 208 by the adhesive 612 and can be peeled away exposing the adhesive 612 about the periphery of the apparatus 500, such that the apparatus 500 can be attached to the user's clothing or skin. The backing 616 is similarly constructed to the backing 606, and can include the tab 802.

In some embodiments of the apparatuses 100, 500, the linerboard 208 can be treated chemically or thermally, such that the surface of the linerboard 208 or an exposed portion 804 of the linerboard 208 is not permeable.

FIG. 9 illustrates a rear isometric view of the example apparatus 900. The apparatus 900 includes the apparatus 100 illustrated in FIG. 1 and a band 902. In other embodiments, the apparatus 900 can similarly include the apparatus 500 instead of apparatus 100.

The band 902 is secured to the linerboard 208 of the apparatus 100 using an adhesive 908. Moreover, the band 902 includes hook 904 and loop 906 sections, which allow the user to attach the apparatus 900 to the arm of the user, such as for example, using one hand of an opposing arm. The hook/loop sections 904, 906 can be replaced with button sections. Alternatively, the band 902 can be a string that is tied. In another alternative, one end of the band 902 can have a tape section that can adhere removeably to the other end of the band 902.

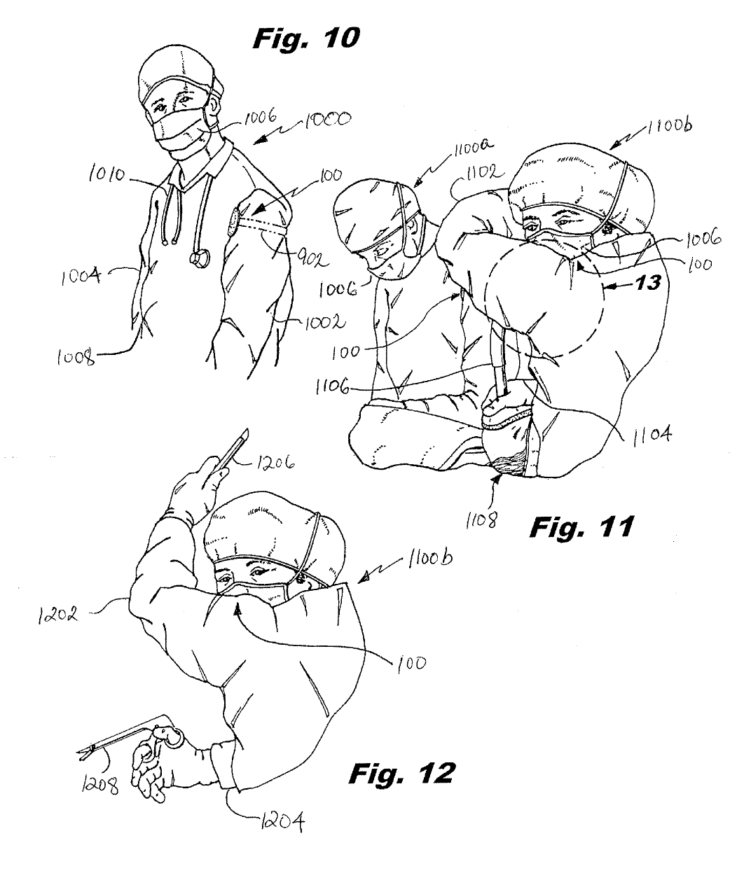

FIG. 10 illustrates example placement of the example apparatuses 100, 500, 900 in accordance with FIGS. 1, 5 and 9. While the following describes the placement of the apparatus 100, it is equally applicable to the placement of the other apparatuses 500, 900.

As illustrated in FIG. 10, a health-related professional (user) 1000 is wearing a mask 1006 and a garment (e.g., scrubs) 1008. In some embodiments, the mask 1006 can be substituted with a respirator (not shown), which should include a non-rigid nose and mouth region. As described hereinabove, the user can be a doctor, a nurse, or other health-related personnel. The user has arms 1002, 1004. Moreover, the user 1000 is depicted carrying a health-related tool (e.g., stethoscope) 1010, with the apparatus 100 being attached an upper portion of the left arm 1002. More specifically, the apparatus 100 is attached to a sleeve of the garment 1008 that the user 1000 is wearing.

The apparatus 100 can similarly be attached at different portions along the left arm 1002 (e.g., inner elbow portion), to different portions of the right arm 1004 (not shown), or several apparatuses 100 can be attached to one or both arms 1002, 1004, in a similar fashion as illustrated in FIG. 10. In some embodiments, the apparatus 100 can also be secured using the band 902 of FIG. 9, as shown in dashed lines in FIG. 10.

In various other placements, the apparatus 100 can be held in the user's hand (not shown) or attached elsewhere on the user 1000, such as along any one of more locations of the garment 1008.

FIGS. 11 and 12 illustrate the example operation of apparatuses 100, 500, 900 in accordance with FIGS. 1, 5 and 9. While the following describes the operation of the apparatus 100, it is equally applicable to the operation of the other apparatuses 500, 900.

As illustrated in FIGS. 11 and 12, doctors 1100a, 1100b are operating on patient 1108. The surgeon 1100a and the anesthesiologist 1110b are wearing masks 1006 and scrubs 1008, respectively. The surgeon 1100a is using surgical tools 1206 (scalpel), 1208 (forceps) depicted in his hands 1202, 1204, while the anesthesiologist 1110b is using an anesthesia device 1106 with her left hand 1102.

In this example, the doctors (users) 1100a, 100b are wearing the apparatuses 100 on their upper left arms, with other locations being possible. As described hereinabove, the apparatus 100 can be worn at various locations of the arms 1102, 1004, 1202, 1204. When a sneeze or cough is imminent, the user position his/her face in relation to the indicator 702 of the apparatus 100 illustrated in of FIG. 7, and presses the user's mouth/nose firmly into the apparatus 100, which also firmly presses the mouth/nose into the mask 1006 (or the respirator).

In operation, the respiratory emission exits the mouth/nose and is partially filtered by the mask 1006 (or the respirator). Because of the firm pressure, the escape of the respiratory emission out of the edges of the mask 1006 is substantially mitigated or eliminated. The partially filtered respiratory emission exits the mask 1006 and enters the apparatus 100. This partially filtered respiratory emission is then further filtered through the apparatus 100 and the filtered air exits the apparatus 100.

As illustrated, the apparatus 100 can be used effectively in combination with masks (e.g., surgical masks), as well as respirators, when one hand 1102 is occupied or when both of the hands 1202, 1204 are occupied, as well as when no hands are occupied. Accordingly, a system that mitigates the spread of disease caused by respiratory emission of a sneeze can include a combination of a mask 1006 (or a respirator, not shown) and an apparatus 100.

It should be noted that the apparatus can similarly be used without a mask. In all cases of use with or without a mask, the user should attempt to sneeze only through the mouth onto/into the apparatus 100, which improves filtration efficiency of the repository emission of the user through the apparatus 100.

FIG. 13 illustrates an exploded cutaway view of the apparatus 100 of FIG. 2 to illustrate filtration of the respiratory emission 1300 through the apparatus 100. While the following describes the operation of the apparatus 100, it is equally applicable to the operation of the other apparatuses 500, 900.

More specifically, respiratory emission 1300 resulting from a sneeze—whether or not partially filtered by a mask 1006—enters the first filtration component 102 of the apparatus 100 through its surface (e.g., surface 700 illustrated in FIG. 7). The first filtration component 102 partially filters the respiratory emission 1300, as described herein. The partially filtered respiratory emission is then further filtered by the second filtration component 104, as also described herein. The filtered air 1302 is then directed along the flutes 306 horizontally out of the spacer component 106 to the outside of the apparatus 100.

It should be noted that in those embodiments of the apparatus illustrated in FIG. 6a, the filtration element 204 further filters any remaining respiratory emission at the peripheral edge 202 before the filtered air exits the apparatus 100. In other embodiments, the filtration component 104 can be provided with additional filtration elements to perform such filtration.

FIG. 14 illustrates the components 102, 104 and 1406 of the apparatus 1400. The apparatus 1400 is similar in construction to the apparatus 100, except for the spacer component 1406.

It is noted that the filtration components 102, 104 were described hereinabove with reference to the embodiments illustrated in FIGS. 1-13.

The spacer component 1406 of the apparatus 1400 includes a linerboard 1408 and a corrugated sheet 1410 forming flutes 1412. The spacer component 1406 can be made of corrugated fiberboard, paper, plastic, or another material. The linerboard 1408 is generally planar. The linerboard 1408 can be omitted, as long as the corrugated sheet 1410 is flexible yet sufficiently rigid to maintain its corrugation, as described hereinabove with reference to the other embodiments. The corrugated sheet 1410 includes a plurality of peaks 1402, and a plurality of valleys 1404 between the peaks 1402.

The peaks 1402 and valleys 1404 form flutes 1412 that direct and/or exhaust the filtered air received from the second filtration component 104 to the outside the example apparatus 1400. It is noted that in this embodiment the flutes 1412 are disposed vertically, from top-to-bottom of the apparatus 1400.

FIG. 15 illustrates the securement of the components 102, 104 and 1406 of the apparatus 1400.

The securement of the first filtration component 102 to the second filtration component 104 was described hereinabove with reference to the embodiments illustrated in FIGS. 1-13.

The filtration elements 204, 205, and 206 of second filtration component 104 can be secured to each other using adhesive as descried hereinabove with reference to the embodiments illustrated in FIGS. 1-13. In some embodiments, the filtration elements 204, 205, 206 are not secured to each other, or are less securely attached to each other, because the filtration element 204 is secured to the underside of the spacer component 1406 encompassing the filtration elements 205, 206 securely in fixed position in relation to the spacer component 1406.

The second filtration component 104—or more particularly, one or more of the filtration elements 204-206—is secured to the underside of the spacer component 1406 (e.g., linerboard 1408) using an adhesive, e.g., as described with reference to FIG. 6a. In the embodiments where the linerboard 1408 is omitted (not shown), the second filtration component 104 is secured to the then underside of the spacer component 1406 (e.g., corrugated sheet 1410) also using an adhesive.

It is noted that in various embodiments, the apparatus 1400 can include similar construction of one or more of the following elements described in reference to the various embodiments of FIGS. 1-13: the peripheral edges 202, 502; the removable backings 606, 616; the indicator 702 of the surface 700; and the band 902.

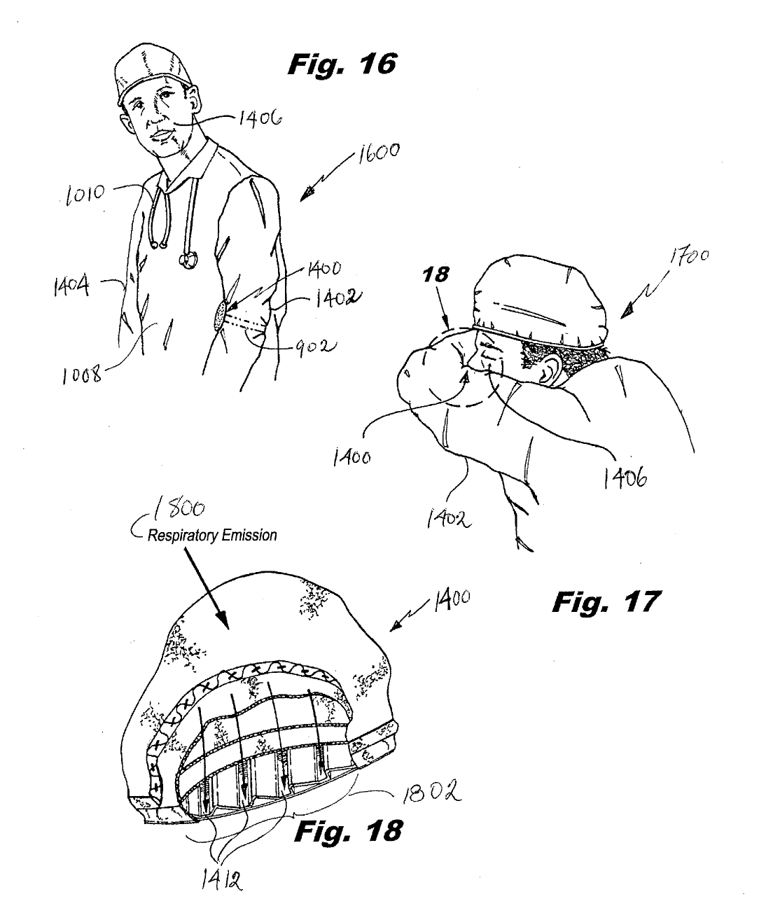

FIG. 16 illustrates example placement of the example apparatus 1400 in accordance with FIG. 14.

As illustrated in FIG. 16, a health-related user 1600 is wearing a garment (e.g., scrubs) 1008, but is not wearing a mask which exposes the user's mouth and nose region 1406. The user 1600 has arms 1402, 1404. Moreover, the user 1600 is depicted carrying a health-related tool (e.g., stethoscope) 1010, with the apparatus 1400 being attached an upper portion of the left arm 1402. More specifically, the apparatus 1400 is attached to a sleeve of the garment 1008 that the user 1600 is wearing.

The apparatus 1400 can similarly be attached at different portions along the left arm 1402 (e.g., inner elbow portion), to different portions of the right arm 1404 (not shown), or several apparatuses 1400 can be attached to one or both arms 1402, 1404, in a similar fashion as illustrated in FIG. 16. In some embodiments, the apparatus 1400 can also be secured using the band 902 of FIG. 9, as shown in dashed lines.

In various other placements, the apparatus 1400 can be held in the hand (not shown) or attached elsewhere on the user 1600, such as along any one of more locations of the garment 1008.

FIG. 17 illustrates the example operation of apparatus 1400 in accordance with FIG. 14.

As illustrated in the example of FIG. 17, the user 1700 is wearing the apparatus 1400 on his upper left arm 1402, with other locations being possible. When a sneeze is imminent, the user position his/her face (mouth/nose region 1406) in relation to the indicator 702 of the apparatus 1400 illustrated in of FIG. 7, and presses the user's mouth/nose region 1406 into the apparatus 1400, creating a seal of the mouth (lips) against the surface 700 of the apparatus 1400. The user should attempt to sneeze only through the mouth onto/into the apparatus 1400, which improves filtration efficiency of the repository emission of the user through the apparatus 1400.

In operation, the respiratory emission of a sneeze exits the mouth/nose and is deposited onto/into the top surface 700 of the apparatus 1400. Because of the firm pressure (e.g., seal of lips to the surface 700 of apparatus 1400), the escape of the respiratory emission off the apparatus 1400 is substantially mitigated or eliminated. The respiratory emission is filtered through the apparatus 1400 and the filtered air exits the apparatus 1400.

In various embodiments, the apparatus 1400 can also be used effectively in combination with masks (e.g., surgical masks) or respirators (not shown) when one hand 1402 is occupied or when both of the hands 1402, 1404 are occupied, as well as when no hands are occupied, in a similar fashion as described with reference to FIGS. 10-13. Accordingly, a system that mitigates the spread of disease caused by respiratory emission of sneezing sneeze can include a mask 1006 and an apparatus 1400.

FIG. 18 illustrates an exploded cutaway view of the assembled apparatus 1400 of FIG. 14 to illustrate filtration of the respiratory emission 1800 through the apparatus 1400.

More specifically, the respiratory emission 1800 resulting from a sneeze—whether or not partially filtered by a mask—enters the first filtration component 102 of the apparatus 1400 through the surface 700. The first filtration component 102 partially filters the respiratory emission 1800, as described herein. The partially filtered respiratory emission is then further filtered by the second filtration component 104, as also described herein. The filtered air 1802 is then directed along the flutes 1412 vertically (upwardly and/or downwardly) out of the spacer component 1406 to the outside of the apparatus 1400.

It should be noted that in those embodiments of the apparatus 1400 constructed as illustrated in FIG. 6a, the filtration element 204 further filters any remaining respiratory emission at the peripheral edge 202 before the filtered air exits the apparatus 1400. In other embodiments, the filtration component 104 can be provided with additional filtration elements to perform such filtration.

Thus, an apparatus, a system and a method of mitigating the spread of disease caused by pathogens in a respiratory emission of a sneeze have been described. The apparatuses 100, 500, 900, 1400 thus described use the tremendous force of a sneeze (e.g., “expiratory event”), which in practice defeats masks and respirators, to enable the use of high filtration media to provide significantly improved filtration efficiency rates (e.g., up to 99% or higher), in the embodiments with and without masks (or respirators). Specifically, the spacer component 106, 1406 creates an enlarged exhaust area that provides little resistance to air flow beneath the filtration components 102, 104, which causes the filtered air 1302, 1802 to take a path of least resistance out of the foregoing apparatuses via the flutes 306, 1412, and which reduces the back pressure of the filtered air 1302, 1802 through the filtration components 102, 104 such that the filtered air 1302, 1802 does not have sufficient force to come back through the filtration components 102, 104. Moreover, the flutes 306, 1412 provide structural rigidity that prevents the exhaust area from being compressed during operation of the foregoing apparatuses, in the embodiments with and without masks. In view of the foregoing, the improved air flow and the reduced back pressure allow denser, higher filtration efficiency media to be used in the foregoing apparatuses thus providing the improved filtration efficiency rates.

Although specific example embodiments have been described, it will be evident that various modifications and changes can be made to these embodiments without departing from the broader scope of this application. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural substitutions and changes can be made without departing from the scope of this application. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention, inventive concept or embodiment. Thus, although specific embodiments have been illustrated and described herein, it should be appreciated that any arrangement calculated to achieve the same purpose can be substituted for the specific embodiments shown. This application is intended to cover any and all adaptations or variations of various embodiments. Combinations of the above embodiments and other embodiments not specifically described herein, will be apparent to those of skill in the art upon reviewing the above description.

The Abstract is provided to comply with 37 C.F.R. §1.72(b) and will allow the reader to quickly ascertain the nature of the technical disclosure of this application. It is submitted with the understanding that it will not be used to interpret or limit the scope or meaning of the claims.

In the foregoing description of the embodiments, various features can be grouped together in a single embodiment for the purpose of streamlining the disclosure of this application. This method of disclosure is not to be interpreted as reflecting that the claimed embodiments have more features than are expressly recited in each claim. Rather, as the following claims reflect, inventive subject matter lies in less than all features of a single disclosed embodiment.

What is claimed is:

1. An apparatus to mitigate the spread of pathogens in a respiratory emission of a sneeze or a cough, the apparatus comprising:
a spacer component comprising a corrugated sheet, the corrugated sheet forming a plurality of directional flutes to direct filtered air out of the apparatus; and
at least one filtration component disposed atop the spacer component, the at least one filtration component filtering the respiratory emission to produce the filtered air.

2. The apparatus of claim 1, wherein the spacer component comprises a linerboard to which the corrugated sheet is secured.

3. The apparatus of claim 1, wherein at least a portion of the linerboard is impermeable.

4. The apparatus of claim 1, wherein the flutes are one of horizontal and vertical.

5. The apparatus of claim 1, wherein the at least one filtration component comprises:
a second filtration component disposed atop the spacer component; and
a first filtration component disposed atop the second filtration component.

6. The apparatus of claim 5, wherein the first filtration component comprises at least antimicrobial properties.

7. The apparatus of claim 5, wherein the second filtration component includes at least virucidal properties.

8. The apparatus of claim 5, wherein the second filtration component includes at least a first filtration element disposed atop a second filtration element.

9. The apparatus of claim 8, wherein the first filtration element is a tissue material.

10. The apparatus of claim 9, wherein the tissue material includes a plurality of plys, wherein one of the plys includes at least virucidal properties.

11. The apparatus of claim 8, wherein the second filtration element is a one of meltbond material or a spunbond material.

12. The apparatus of claim 8, wherein the first filtration element extends over periphery of the apparatus and is secured to an underside of the spacer component.

13. The apparatus of claim 1, wherein a top surface of at least one filtration component includes an indicator, the indicator including one or more a mouth, a nose, and a textual indication.

14. The apparatus of claim 1, wherein the apparatus comprises a removable backing that exposes adhesive enabling the apparatus to be secured to a garment.

15. The apparatus of claim 1, wherein the apparatus comprises a removable backing that exposes adhesive enabling the apparatus to be secured to skin of a user.

16. The apparatus of claim 1, wherein the apparatus comprises a band secured to the spacer component, the band enabling the apparatus to be secured to a user.

17. The apparatus of claim 16, wherein the band includes a hook and loop to secure the band.

18. A system to mitigate the spread of pathogens in a respiratory emission of a sneeze or a cough, the system comprising:
a mask partially filtering the respiratory emission to produce partially filtered the respiratory emission; and
an apparatus comprising:
a spacer component comprising a corrugated sheet, the corrugated sheet forming a plurality of directional flutes to direct filtered air out of the apparatus; and
at least one filtration component disposed atop the spacer component, the at least one filtration component filtering the partially filtered respiratory emission to produce the filtered air.

19. A method of mitigating the spread of pathogens in a respiratory emission of a sneeze or a cough, the method comprising:
filtering the respiratory emission through at least one filtration component to produce filtered air; and
directing the filtered air through a spacer component comprising a corrugated sheet, the corrugated sheet forming a plurality of directional flutes that direct the filtered air out along the directional flutes.

20. The method of claim 19, further comprising receiving a person's nose and mouth region in conformity with the at least one filtration component.

21. The method of claim 19, further comprising receiving a person's nose and mouth region in conformity with an indicator, the indicator including a representation of a mouth and nose region.

22. The method of claim 19, further comprising filtering the respiratory emission through a mask before filtration through the at least one filtration component.
